(19) United States
(12) Patent Application Publication
(10) Pub. No.: US 2013/0063305 A1
(43) Pub. Date: Mar. 14, 2013

(54) FREQUENCY CALIBRATION METHOD AND SATELLITE POSITIONING SYSTEM UTILIZING THE METHOD

(71) Applicants: Chi-Yeh Lo, Taoyuan County (TW); Hsin-Chung Yeh, Hsinchu City (TW)

(72) Inventors: Chi-Yeh Lo, Taoyuan County (TW); Hsin-Chung Yeh, Hsinchu City (TW)

(21) Appl. No.: 13/415,820

(22) Filed: Mar. 8, 2012

Related U.S. Application Data
(63) Continuation-in-part of application No. 12/372,745, filed on Feb. 18, 2009, now abandoned.

(51) Int. Cl. G01S 19/23

(52) U.S. Cl. 342/357.62

(57) ABSTRACT

A frequency calibration method and a satellite positioning system utilizing the frequency calibration method are disclosed. The frequency calibration method includes the following steps: detecting a plurality of chip state parameters; and determining a frequency drift and a frequency variation of a target signal according to the detected chip state parameters.

### CROSS REFERENCE TO RELATED APPLICATIONS

The present application is a Continuation-In-Part application of U.S. patent application Ser. No. 12/372,745 filed on Feb. 18, 2009, which is all incorporated by reference herein.

### BACKGROUND OF THE INVENTION

The present invention relates to a frequency calibration method and a satellite positioning system utilizing the methods, and particularly relates to a frequency calibration method utilizing at least a chip state parameter and a satellite positioning system utilizing the methods.

A satellite positioning system such as a GPS system comprises an oscillator for providing a clock signal to the devices in the system. However, the frequency of the oscillator will vary due to different temperature, as shown in FIG. 1. FIG. 1 is a schematic diagram illustrating an S-curve indicating the frequency-temperature relation for an oscillator, wherein the vertical axis indicates the range of frequency drift in parts per million (PPM) of the oscillator. It is apparent that the frequency changes corresponding to different temperature. Therefore, the operation of the satellite positioning system will be affected accordingly, if no compensation for this situation is performed.

A TCXO (temperature compensating oscillator) can be utilized to compensate, however, the cost and the occupied area region of TCXO is much higher than a normal oscillator, which increases the difficulty for designing a system and the cost for manufacturing a satellite positioning system.

### SUMMARY OF THE INVENTION

One embodiment of the present invention discloses a calibration method for calibrating a target signal of a chip. The method comprises: detecting a plurality of chip state parameters; and determining a frequency drift and a frequency variation of the target signal according to the detected chip state parameters.

Another embodiment of the present invention discloses an oscillator, a chip, and a processor. The chip includes an IF down converter, an ADC, a baseband generator and a PLL. The oscillator generates a clock signal. The chip receives a satellite signal to generate a baseband signal according to the clock signal. The IF down converter down converts an RF signal to generate a first signal. The ADC converts the first signal to a second signal. The baseband signal generator converts the second signal to a baseband signal. The PLL generates a third signal according to the clock signal. The processor determines a frequency drift and a frequency variation according to a plurality of chip state parameters which are output from a chip state parameter detector.

According to above-mentioned embodiments, the frequency variation due to temperature or other chip parameters can be compensated without utilizing a TCXO. Thus the issue described in the related art can be avoided.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an S-curve indicating frequency-temperature relation for an oscillator.

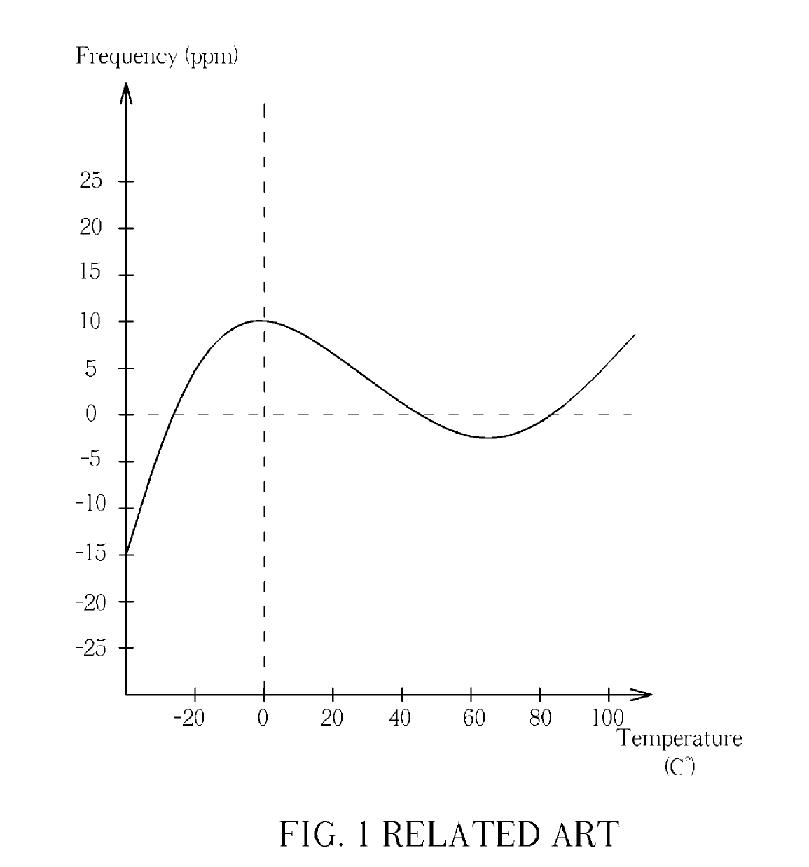

FIG. 2 is a block diagram illustrating a satellite positioning system utilizing a calibrating method according to embodiments of the present invention.

FIG. 3 is a lookup table illustrating the relationship between the chip state parameters and frequency drifts and frequency variations.

FIG. 4 is a schematic diagram illustrating the steps of calibrating the frequency center of the target signal according to the frequency drift.

FIG. 5 is a flowchart illustrating frequency calibration method according to an embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

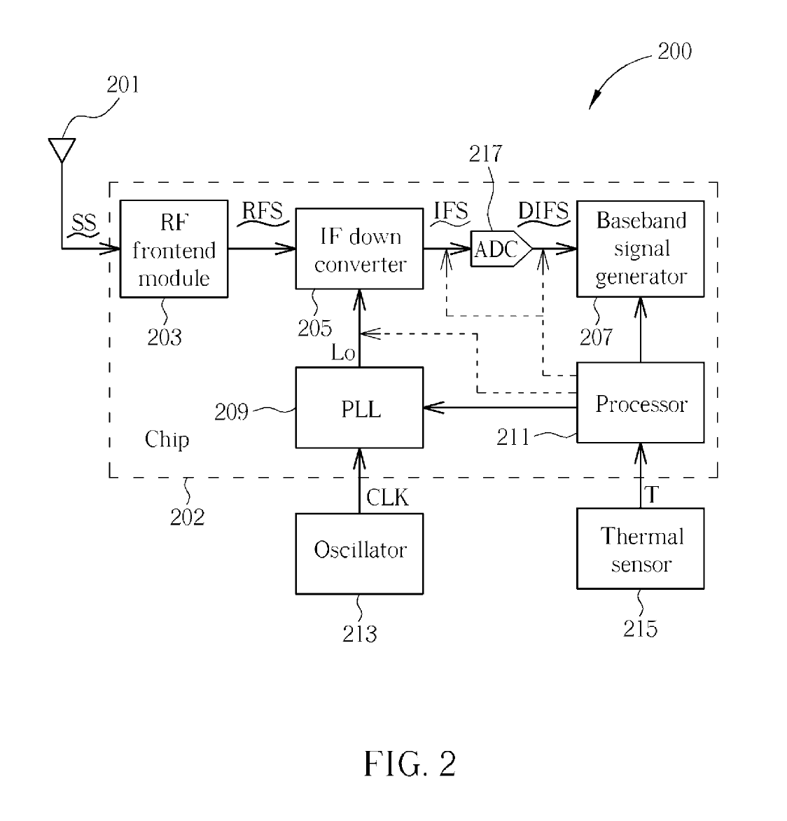

FIG. 2 is a block diagram illustrating a satellite positioning system 200 utilizing a frequency calibration method according to embodiments of the present invention. It should be noted that the devices shown in FIG. 2 are only for example and do not mean to limit the scope of the present invention to the devices shown in FIG. 2.

As shown in FIG. 2, the satellite positioning system 200 comprises an antenna 201, a RF front end module 203, a IF down converter 205, a baseband signal generator 207, a PLL 209, a processor (central processing unit) 211, an oscillator 213, and a thermal sensor 215. The antenna 201 serves to receive a satellite signal SS. The RF front end module 203 serves to generate a RF signal RFS according to the satellite signal SS. The IF down converter 205 serves to down convert the RF signal to generate an IF signal IFS. The baseband signal generator 207 serves to generate a baseband signal BS according to the IF signal IFS. The PLL 209 serves to generate a local oscillating signal LO according to a clock signal CLK. The processor 211 serves to control operation of the satellite positioning system 200 and perform the frequency calibration steps. The oscillator 213 serves to provide the clock signal CLK. In one embodiment of the present invention, The thermal sensor 215 serves to detect a thermal parameter T of a chip 202 comprising the RF front end module 203, an IF downconverter 205, a baseband signal generator 207, a PLL 209, and a processor (central processing unit) 211. The thermal sensor 215 is a low resolution temperature sensor having a resolution lower than which of a TCXO, and the thermal sensor 215 outputs a plurality of thermal parameters respectively representing different temperature range.

After receiving the thermal parameter from the thermal sensor 215, the processor 211 can perform frequency calibration steps according to the thermal parameter and the other kinds of chip state parameters. The frequency calibration steps can be performed to the local oscillating signal LO. In this case, the processor 211 can vary parameters of the PLL 209, and thus the frequency of LO can be changed accordingly. Additionally, if the satellite positioning system 200 comprises an ADC (analog to digital converter) 217 located between the IF downconverter 205 and the baseband signal generator 207, the frequency calibration steps can be performed to the IF signal IFS or a digital IF signal DIFS, which is generated via the ADC 217 according to the IF signal IFS. In this case, the processor 211 adjusts the parameters of a voltage control oscillator in the baseband signal generator 207 to calibrate the frequency. Briefly, frequency calibration steps can be performed to a target signal, which can be the local oscillating signal LO, the IF signal IFS or the digital IF signal DIFS.

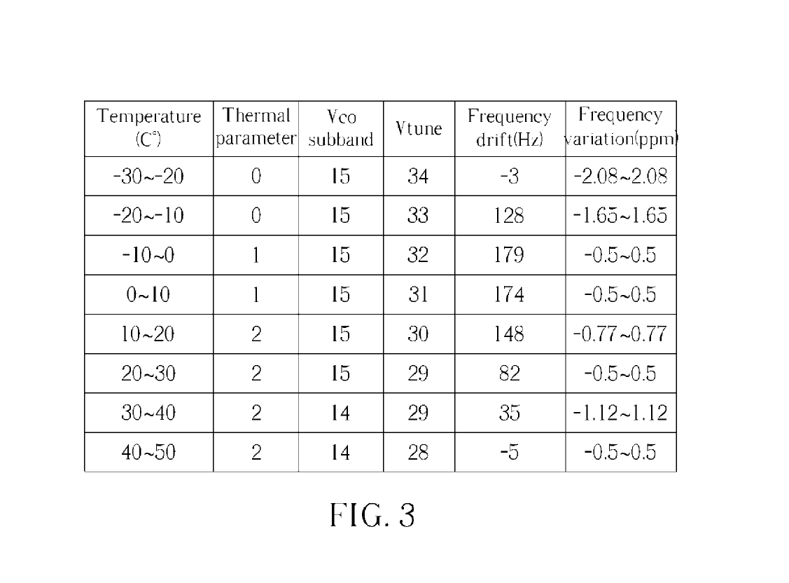

In this embodiment, the chip 202 has a plurality of operation states corresponding to different thermal parameters and other parameters of the chip. The frequency calibration steps are performed according to the different thermal parameters and other chip state parameters. FIG. 3 is a lookup table illustrating the relationship between the chip state parameters and frequency drifts and frequency variations. The frequency drifts and the frequency variations could be determined from the lookup table by looking up chip parameters. As shown in FIG. 3, the other chip state parameters can comprise parameters, such as a VCO sub-band parameter, and a Vtune parameter. The VCO sub-band parameter indicates the range that a VCO (voltage control oscillator) in the baseband signal generator 207 can support (i.e. the range of a sub-band). The Vtune parameter indicates the number of sub-bands that can be utilized. By this way, the frequency drifts and the frequency variations can be determined once the current temperature sensor's output, the VCO sub-band parameter, and the Vtune parameter are obtained. It should be noted that the data shown in FIG. 3 are experiment data only for example and do not mean to limit the scope of the present invention to the data shown in FIG. 3.

For example, if the thermal sensor indicates that the thermal parameter is 0, and the VCO sub-band parameter and the Vtune parameter are respectively 15 and 34, it can be determined that the chip operates in the temperature −30˜−20° C. The frequency variation and the frequency drift can be determined to −2.08˜+2.08 and −3 respectively from the lookup table as shown in FIG. 3. Similarly, if the thermal sensor indicates that the thermal parameter is 1, and the VCO sub-band parameter and the Vtune parameter are respectively 15 and 32, the frequency variation and the frequency drift can be determined to −0.5˜+0.5 and 179 respectively by the same lookup table.

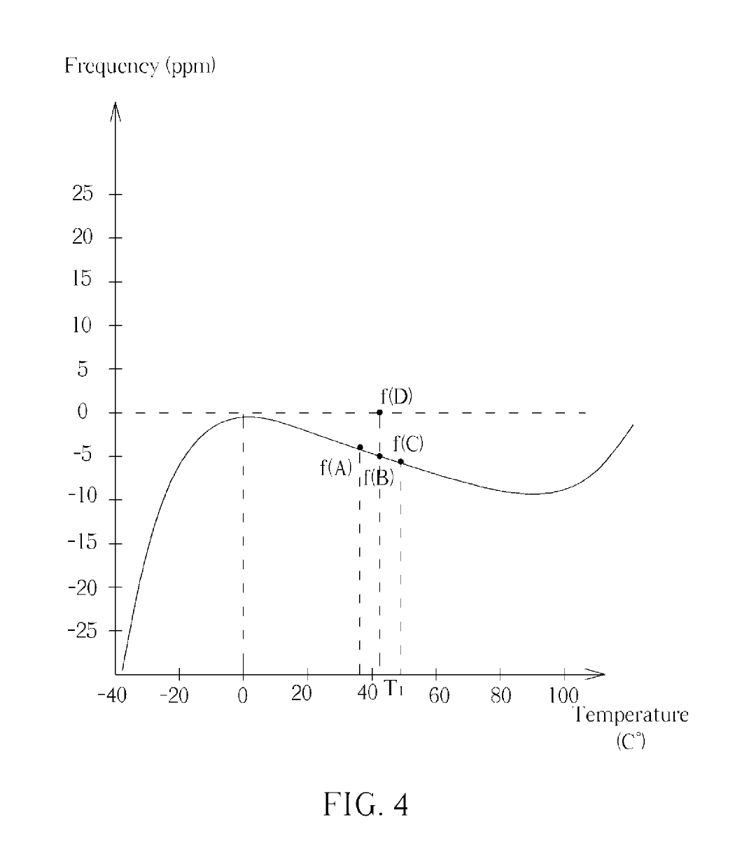

FIG. 4 is a schematic diagram illustrating the steps of calibrating the frequency center of the target signal according to the frequency drift. As shown in FIG. 4, f(D) indicates a frequency value where no frequency drift occurs. Additionally, at a temperature T₁, e.g. 42° C., a frequency drift f(B) is determined according to a lookup table as shown in FIG. 3, then frequency center can be computed according to the frequency drift, i.e. frequency center=frequency×(1−f(B)). Further, the frequency variation

$$\pm \frac{\vert f ( A ) - f ( C ) \vert}{2}$$

can also be determined according to the chip state parameters as shown in FIG. 3. Once the frequency variation and the frequency center are obtained, the variation of the frequency center can be calculated, i.e. the variation of the frequency center=frequency center+frequency variation×frequency. As shown in FIG. 4, the frequency variation of the frequency center is f(C)˜f(A).

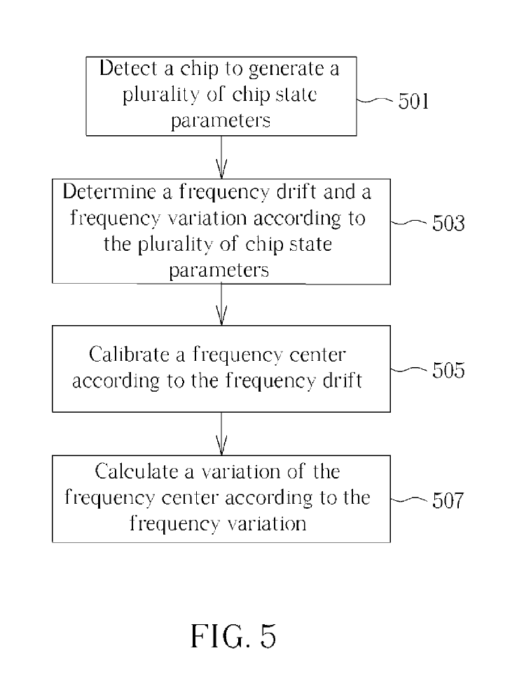

FIG. 5 is a flowchart illustrating a calibration method according to an embodiment of the present invention. The method comprises:

Step 501

Detect a chip to generate a plurality of chip state parameters.

Step 503

Determine a frequency drift and a frequency variation according to the detected plurality of chip state parameters.

Step 505

Calibrate a frequency center (i.e. f(B) in FIG. 4) according to the frequency drift.

Step 507 calculate a variation of the frequency center according to the frequency variation.

Other detailed characteristics are illustrated in the above-mentioned embodiments, and thus are omitted for brevity.

According to the above-mentioned embodiments, the frequency drift due to temperature or other chip parameters can be compensated without utilizing a TCXO. Thus the issue described in the related art can be avoided.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A frequency calibration method for calibrating a frequency center and a variation of the frequency center of a target signal used in a chip, comprising:
detecting a plurality of chip state parameters; and
determining a frequency drift and a frequency variation of the target signal according to the detected chip state parameters.

2. The method of claim 1, further comprising:
calibrating a frequency center of the target signal according to the frequency drift; and
calculating a variation of the frequency center according to the frequency variation.

3. The method of claim 1, wherein the chip state parameters comprise a thermal parameter of the chip.

4. The method of claim 1, wherein the chip comprises a voltage control oscillator, wherein the chip state parameters comprise a VCO sub-band parameter, or a Vₜᵤₙₑ parameter, wherein the VCO sub-band parameter indicates the range that the voltage control oscillator can support, and the Vₜᵤₙₑ parameter indicates the number of sub-bands that can be utilized.

5. The method of claim 1, wherein the chip comprises a voltage control oscillator, and the chip state parameters comprises a frequency range that the voltage control oscillator can support.

6. The method of claim 1, wherein the chip is for a satellite positioning system, and the method further comprising:
determining a satellite searching range of the satellite positioning system according to the frequency variation.

7. The method of claim 6, wherein the satellite positioning system comprises an oscillator for generating a clock signal, and the method further comprises:
generating the target signal according to the clock signal; and
down converting an RF signal according to the target signal.

8. The method of claim 6, further comprising:
down converting an RF signal to generate the target signal;
converting the target signal to a digital IF signal; and
converting the digital IF signal to a baseband signal.

9. The method of claim 6, further comprising:
down converting an RF signal to generate an IF signal;
converting the IF signal to the target signal; and
converting the target signal to a baseband signal.

10. A satellite positioning system, comprising:
an oscillator for generating a clock signal;
a chip, for receiving a satellite signal to generate a baseband signal according to the clock signal, comprising:
an IF down converter, for down converting an RF signal to generate a first signal;
an ADC, for converting the first signal to a second signal;
a baseband signal generator, for converting the second signal to the baseband signal;
a PLL, for generating a third signal according to the clock signal; and
a processor, for detecting a plurality of chip state parameters; and
determining a frequency drift and a frequency variation according to a plurality of chip state parameters.

11. The system of claim 10, wherein the processor further calibrates a frequency center of at least one of the first signal, the second signal and the third signal according to the frequency drift; and calculates a variation of the frequency center according to the frequency variation.

12. The system of claim 10, wherein the chip state parameter detector is a thermal detector and the chip state parameter comprises a temperature of the chip.

13. The system of claim 10, wherein the chip includes a voltage control oscillator, and the chip state parameters comprise a VCO sub-band parameter, or a Vₜᵤₙₑ parameter, wherein the VCO sub-band parameter indicates the range that the voltage control oscillator can support, and the Vₜᵤₙₑ parameter indicates the number of sub-bands that can be utilized.

14. The system of claim 10, wherein the chip has a plurality of operation states corresponding to different chip state parameters.

15. The system of claim 11, wherein the processor further determines a satellite searching range of the satellite positioning system according to the frequency variation.
